(19) United States
(12) Patent Application Publication
(10) Pub. No.: US 2023/0151716 A1
(43) Pub. Date: May 18, 2023

(54) SYSTEM AND METHOD FOR HISTORY MATCHING RESERVOIR SIMULATION MODELS

(71) Applicant: SAUDI ARABIAN OIL COMPANY, Dhahran (SA)

(72) Inventors: Marwah Mufid Alsinan, Al Qatif (SA); Xupeng He, Thuwal (SA); Hyung Tae Kwak, Dhahran (SA); Hussein Hoteit, Thuwal (SA)

(73) Assignees: SAUDI ARABIAN OIL COMPANY, Dhahran (SA); King Abdullah University of Science and Technology, Thuwal-Jeddah (SA)

(21) Appl. No.: 17/455,633

(22) Filed: Nov. 18, 2021

(51) Int. Cl. E21B 43/00

(52) U.S. Cl. CPC E21B 43/00; E21B 2200/20

(57) ABSTRACT

A method for history matching utilizing Bayesian Markov Chain Monte Carlo (MCMC) workflow may include selecting a reservoir simulation model of interest, identifying a mathematical model relevant to the reservoir simulation model, and identifying a plurality of history matching parameters as initial priors. The method may include constructing a first model, utilizing the initial priors, to obtain updated priors. The method may include constructing a second model to obtain posteriors. The method may include determining history matching accuracy of the reservoir simulation model by comparing medians of the posteriors and a plurality of measured data. The method may further include, upon determining accuracy of the reservoir simulation model, performing a plurality of predictions of a reservoir.

### BACKGROUND

Following construction of a reservoir simulation model, history matching is a process to synchronize the simulation model with production data. History matching is a critical step in reservoir simulation modeling and reservoir management. A history-matched model can be used to simulate future reservoir behavior with higher accuracy, and can be further used for optimal field development, performance optimization, and uncertainty quantifications. Computational cost, uncertainty quantification, and consistency of the reservoir simulation models are three key factors that need to be taken into consideration in a history matching process. Currently, there are two main history matching approaches for reservoir simulation models. One is the traditional approach, which relies on trial-error in adjusting the multipliers to minimize mismatch between a model's forecasts and measured data. The other is the modern approach, which uses computerized algorithm to directly tune parameters. The traditional approach is inefficient and highly depends on human interpretation. The modern approach is highly affected by prior selection, likelihood calculation, and posterior samplings.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for history matching utilizing Bayesian Markov Chain Monte Carlo (MCMC) workflow that includes selecting, by a computer processor, a reservoir simulation model of interest. The method includes identifying, by the computer processor, a mathematical model relevant to the reservoir simulation model. The method includes identifying, by the computer processor, a plurality of history matching parameters relevant to the reservoir simulation model as initial priors. The method includes constructing, by the computer processor utilizing the initial priors, a first model. The method includes obtaining, by the computer processor and utilizing the first model, updated priors. The method includes constructing, by the computer processor, a second model. The method includes obtaining, by the computer processor and utilizing the second model, posteriors. The method includes determining, by the computer processor, history matching accuracy of the reservoir simulation model by comparing medians of the posteriors and a plurality of measured data. The method includes, upon determining that the reservoir simulation model is accurate, performing, by the computer processor utilizing the reservoir simulation model, a plurality of predictions of a reservoir.

In one aspect, embodiments relate to a system for performing history matching utilizing Bayesian MCMC workflow. The system includes a history matching manager comprising a computer processor. The history matching manager selects a reservoir simulation model of interest. The history matching manager identifies a mathematical model relevant to the reservoir simulation model. The history matching manager identifies a plurality of history matching parameters relevant to the reservoir simulation model as initial priors. The history matching manager constructs, utilizing the initial priors, a first model, and obtains, utilizing the first model, updated priors. The history matching manager construct a second model and obtains, utilizing the second model, posteriors. The history matching manager determines history matching accuracy of the reservoir simulation model by comparing medians of the posteriors and a plurality of measured data. The history matching manager, upon determining that the reservoir simulation model is accurate, performs, utilizing the reservoir simulation model, a plurality of predictions of a reservoir.

In some embodiments, embodiments relate to a non-transitory computer readable medium storing instructions. The instructions select a reservoir simulation model of interest. The instructions identify a mathematical model relevant to the reservoir simulation model. The instructions identify a plurality of history matching parameters relevant to the reservoir simulation model as initial prior. The instructions construct utilizing the initial priors, a first model, and obtain, utilizing the first model, updated priors. The instructions constructing a second model, and obtain, utilizing the second model, posteriors. The instructions determine history matching accuracy of the reservoir simulation model by comparing medians of the posteriors and a plurality of measured data. The instructions, upon determining that the reservoir simulation model is accurate, perform, utilizing the reservoir simulation model, a plurality of predictions of a reservoir.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a flowchart in accordance with one or more embodiments.

FIG. 3 shows an example expanding on one or more of the steps shown in FIG. 2.

FIGS. 4A-4E show an example expanding on one or more of the steps shown in FIG. 2.

FIGS. 5A and 5B show an example expanding on one or more of the steps shown in FIG. 2.

FIGS. 6A and 6B show an example expanding on one or more of the steps shown in FIG. 2.

FIG. 7A shows a workflow in accordance with one or more embodiments.

FIG. 7B shows a workflow expanding on one or more steps shown in FIG. 7A.

FIG. 8 shows a computing device in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As mentioned above, in order to achieve successful history matching results of reservoir simulation models, three challenges, computational cost, uncertainty quantification, and consistency of the reservoir simulation models must be overcome. Among all of various traditional and modern methods, the Bayesian Markov Chain Monte Carlo (MCMC) history matching method provides a rigorous framework for performing model calibration while considering uncertainties.

Bayesian statistics is a system for describing uncertainty using the mathematical language of probability. In Bayesian statistics, the probability expresses a degree of belief in an event. The degree of belief may be based on prior knowledge about the event, such as the results of previous experiments, or on personal beliefs about the event. Such degree of belief may be referred as prior, or prior distribution. Bayesian statistical method starts with an existing prior and updates the prior using various measured data to give a posterior (or posterior distribution), the latter of which is used as the basis for inferential decisions. More specifically, in this system, the prior is assigned, which represents an evaluation or prediction of an event before obtaining data; the posterior represents an evaluation or evaluation of the event based on the obtained data. In particular, the prior is combined with likelihood to provide the posterior. The likelihood is derived from an aleatory sampling model.

The above described Bayesian statistical procedure, i.e., obtaining the posterior based on the prior and the likelihood, may be commonly realized by MCMC methods. MCMC methods comprise a class of algorithms for statistical sampling, and developing posterior by utilizing the knowledge from the prior through the statistical sampling and by calculating the likelihood. In particular, the more steps included in a MCMC method, the more closely the distribution of the sample matches the actual desired distribution. Examples of MCMC algorithms include: Metropolis-Hastings, Reversible Jump, and Hamiltonian Monte Carlo. MCMC methods are highly affected by prior selection, likelihood calculation, and posterior sampling.

This disclosure aims to provide a history matching method and a system that employ Bayesian MCMC workflow. Specifically, the method develops efficient and cost-effective multi-fidelity models. Further, the method provides proper prior selection, optimum likelihood calculation, and optimum posterior sampling. As a result, the method and system in the disclosure provide precise and physical consistent history matching results.

In general, embodiments of the disclosure include developing a coarse low-fidelity model using Design of Experiment (DoE). DoE is a branch of applied statistics, and refers to the design of a task to study the relationship between multiple input variables and key output variables. As one example, DoE studies effects of multiple input variables or factors on a desired output or response, and may predict the desired output or responses accordingly. DoE may identify and select suitable independent, dependent, and control variables, but planning the delivery of the experiment under statistically optimal conditions given the constraints of available resources.

Embodiments of the disclosure also include constructing a fine low-fidelity model. Embodiments of the disclosure further include feeding posterior into a high-fidelity model to evaluate history matching quality. In particular, the coarse low-fidelity model aims to update initial priors to further improve history matching accuracy. Moreover, by running the fine low-fidelity model in Bayesian workflow, which is a surrogate model of the high-fidelity model, history matching cost is reduced while maintaining physics and accuracy of the high-fidelity model. More specifically, as a surrogate model, the fine low-fidelity model does not only accurately presents the high-fidelity model by providing acceptable results, but also maintains physics consistency of the high-fidelity model so that it captures the trend of the high-fidelity model.

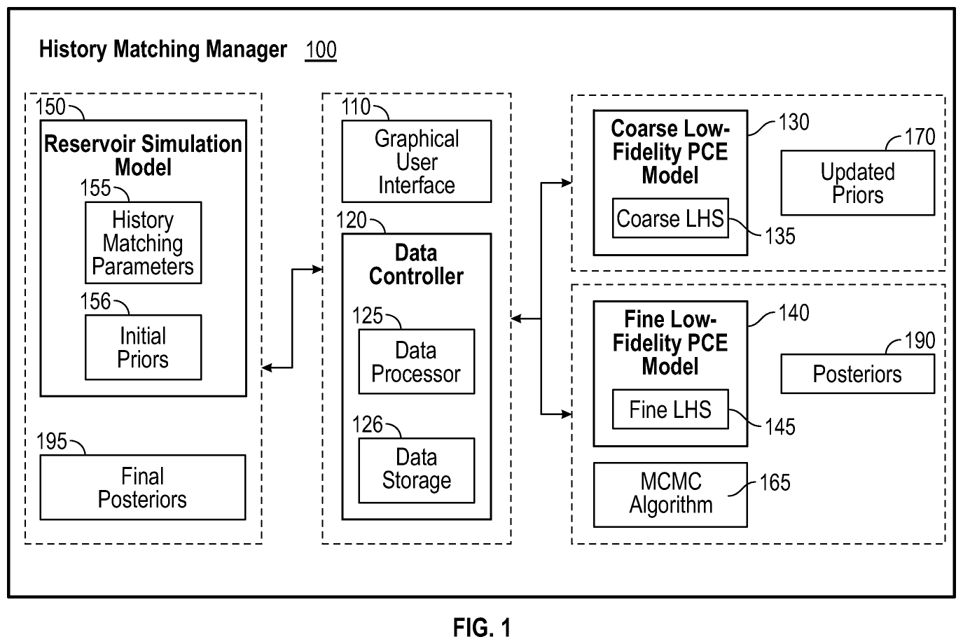

FIG. 1 shows a block diagram of a system in accordance with one or more embodiments. As shown in FIG. 1, a history matching manager (100) may be software and/or hardware implemented on a network, such as a network controller, and includes functionalities for determining and/or managing history matching results of a high-fidelity reservoir model (150). For example, the history matching manager (100) may obtain history matching parameters (155) as priors, develop multiple low-fidelity models under Bayesian framework, generate posterior, and/or determine history matching quality.

Keeping with FIG. 1, the high-fidelity reservoir model (150) is a reservoir simulation model that is selected to be calibrated. The reservoir simulation model is a computer model used for predicting fluid flow, such as oil, water, and gas in porous media. The reservoir simulation model is constructed based on geological and fluid physical data of a underground reservoir. The reservoir simulation model may be a 2D model or a 3D model. The high-fidelity reservoir model (150) includes history matching parameters (155), which refers to a set of parameters with associated uncertainty that affect prediction variance and precision of the high-fidelity reservoir model (150). The history matching parameters (155) may be obtained from available measured data of a reservoir of interest, or from reservoir analogues in literature. However, source of the history matching parameters (155) is not limited to these examples. In particular, initial distributions of the history matching parameters (155) are obtained as initial priors (156).

In some embodiments, the history matching manager may include a graphical user interface (GUI) (110) that receives instructions and/or inputs from users. More specifically, the users may enter various types of instructions and/or inputs via the GUI (110) to start certain actions, such as obtaining, calculating, evaluating, selecting, and/or updating data or parameters. In addition, the users may obtain various types of results from the certain actions via the GUI (110) as outputs.

In some embodiments, the history matching manager (100) may include a data controller (120). The data controller (120) may be software and/or hardware implemented on any suitable computing device, and may include functionalities for selecting, obtaining, and/or, processing data from the high-fidelity reservoir model (150), including the history matching parameters (155). The data controller (120) may include data processors (125) and data storage (126). Specifically, the data processors (125) process the data from the high-fidelity reservoir model (150) as well as the data stored in the data storage (126). The data storage (126) may store various data from the high-fidelity reservoir model (150), and other data and parameters for the other components and functionalities of the history matching manager (100).

Keeping with FIG. 1, the history matching manager (100) may include a coarse low-fidelity Polynomial Chaos Expansion (PCE) Model (130) to generate updated priors (170) based on the initial priors (156). PCE is a method to represent a random variable in terms of a polynomial function of other random variables. PCE is used to effectively deal with probabilistic uncertainty in the parameters of a system, such as to determine the evolution of uncertainty in a dynamical system when there is probabilistic uncertainty in the system parameters. PCE is a set of polynomial basis functions, written as equation (1)

$$G ( ξ ) = {\sum }_{α ∈ A} {g}_{α} {ψ}_{α} ( ξ ) \qquad ( 1 )$$

where ψ_{α}(ξ) is an orthogonal basis function, and ξ is a vector of random ariables linked to model parameters. The subscript α denotes a multi-index scheme, where α∈A and

$$α ≡ {α}_{q}^{l} = \{ \begin{matrix}\begin{matrix}\begin{matrix}{α}_{1}^{1} , {α}_{1}^{2} , … , {α}_{1}^{( {N}_{b} + 1 )} \\ {α}_{2}^{1} , {α}_{2}^{2} , … , {α}_{2}^{( {N}_{b} + 1 )}\end{matrix} \\ ⋮\end{matrix} \\ {α}_{{N}_{opt}}^{1} , {α}_{{N}_{opt}}^{2} , … , {α}_{{N}_{opt}}^{( {N}_{b} + 1 )}\end{matrix} \} .$$

q is the index of model parameter and l is the index of basis function. α returns the polynomial degree.

As mentioned above, MCMC methods are highly affected by prior selection. Therefore, in order to obtain more accurate history matching result, the initial priors (156) are updated by the coarse low-fidelity PCE model (130) to obtain updated priors (170). More specifically, the coarse low-fidelity PCE model (130) improves bounds of the initial priors (156) by utilizing one or more PCE methods to obtain the updated priors (170). In particular, the updated priors (170) are used as priors in the Bayesian framework adopted by the history matching manager (100).

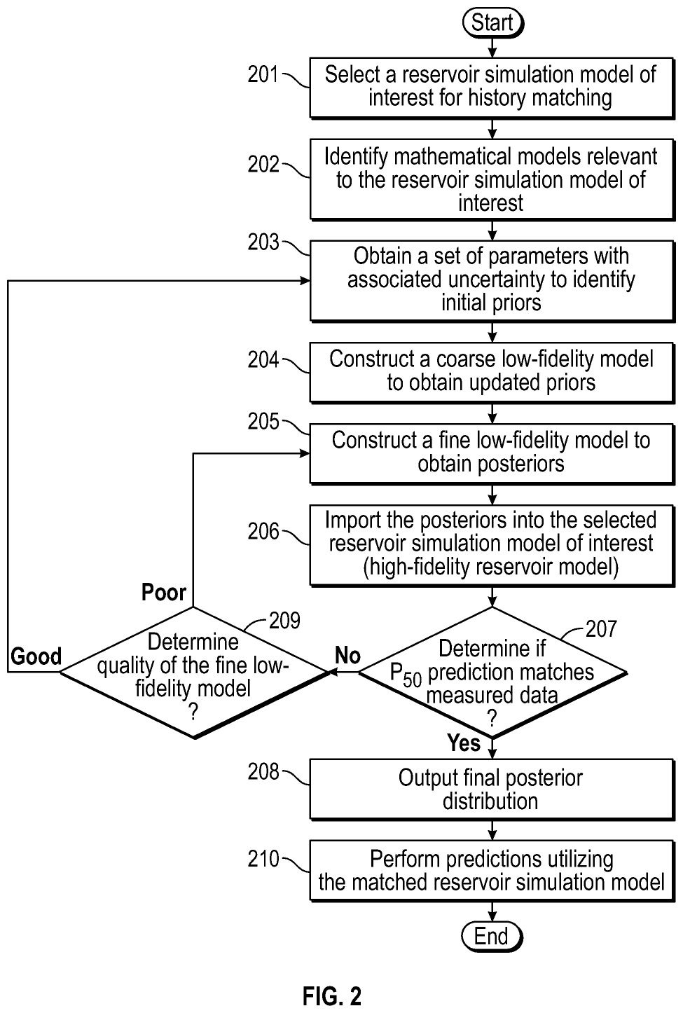

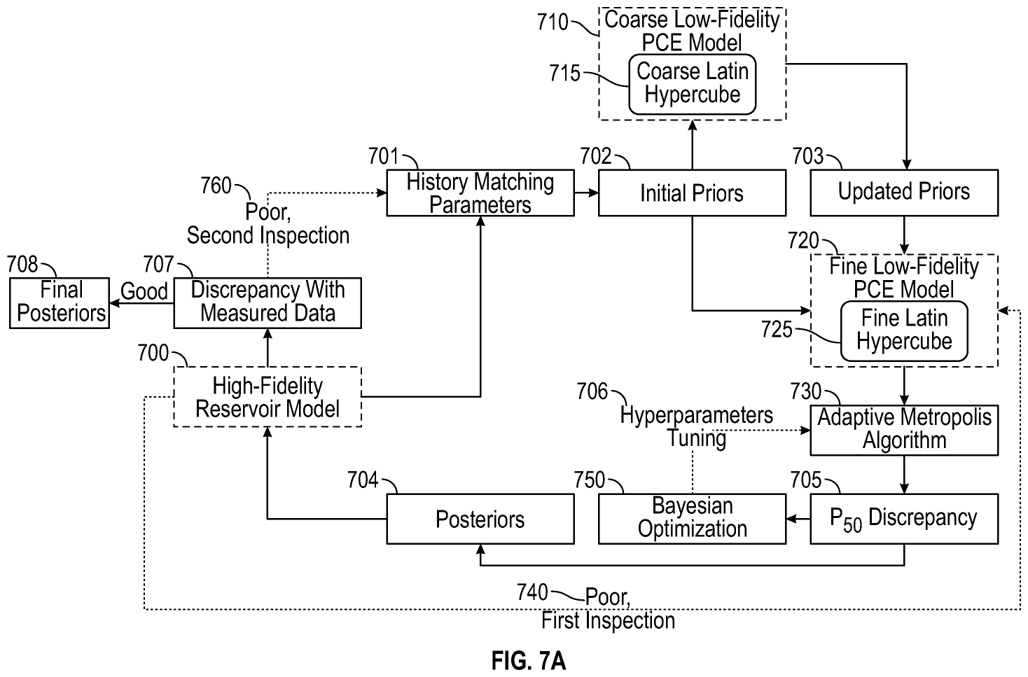

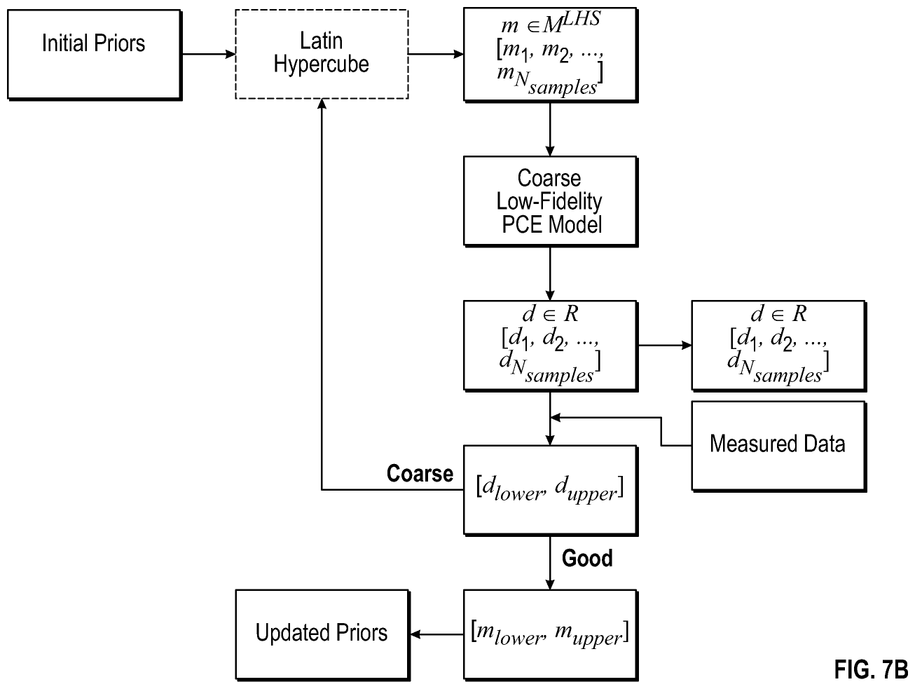

In some embodiments, the coarse low-fidelity PCE model (130) may be constructed utilizing coarse Latin Hypercube Sampler (LHS) (135). Details of the coarse low-fidelity PCE model (130) and the coarse LHS (135) are explained below in FIGS. 2 and 7B, and the accompanying description.

Further, the history matching manager (100) may include a fine-low-fidelity PCE model (140) and an MCMC algorithm (165) to generate posteriors (190). For example, the MCMC algorithm (165) may refer to at least one of the MCMC algorithm examples mentioned above. The posteriors (190) represent predicted distributions of the history matching parameters (155) based on the updated priors (170). Similar to the coarse low-fidelity PCE model (130), the fine low-fidelity PCE model (140) obtains the posteriors (190) by utilizing one ore more PCE methods.

In some embodiments, the fine low-fidelity PCE model (140) may be constructed utilizing fine LHS (145). Compared to the coarse LHS (135), the fine LHS (145) may use a larger training set for sampling. In some embodiments, 2-5% of sample size of the fine low-fidelity PCE model (140) is used to generate the coarse low-fidelity model (130). In particular, the fine low-fidelity PCE model (140) is an cost-effective substitute model representing the high-fidelity reservoir model (150). Details of the fine low-fidelity PCE model (140) are explained below in FIGS. 2 and 7A, and the accompanying description.

Further, the history matching manager (100) may include functionality to feed the generated posteriors (190) back to the high-fidelity reservoir model (150) to determine whether the history matching produces accurate and physically consistent results. Upon determining good quality of the history matching, the corresponding posteriors are referred as final posteriors (195). Once the final posteriors (195) are determined, the successfully history matched high-fidelity reservoir model (150) is applied for future predictions, such as predicting oil and gas productions, etc.

In some embodiments, the GUI (110) and the data controller (120) are coupled to the various models (130, 140, and 150), so that the various models perform their functionalities upon receiving instructions or inputs from the users. In some embodiments, the initial priors (156), the updated priors (170), the posteriors (190), and the posteriors (195) are obtained, generated, processed, and/or stored by the data controller (120), and are delivered to the users through the GUI (110).

While FIG. 1 shows various configurations of components, other configurations may be used without departing from the scope of the disclosure. For example, various components in FIG. 1 may be combined to create a single component. As another example, the functionality performed by a single component may be performed by two or more components.

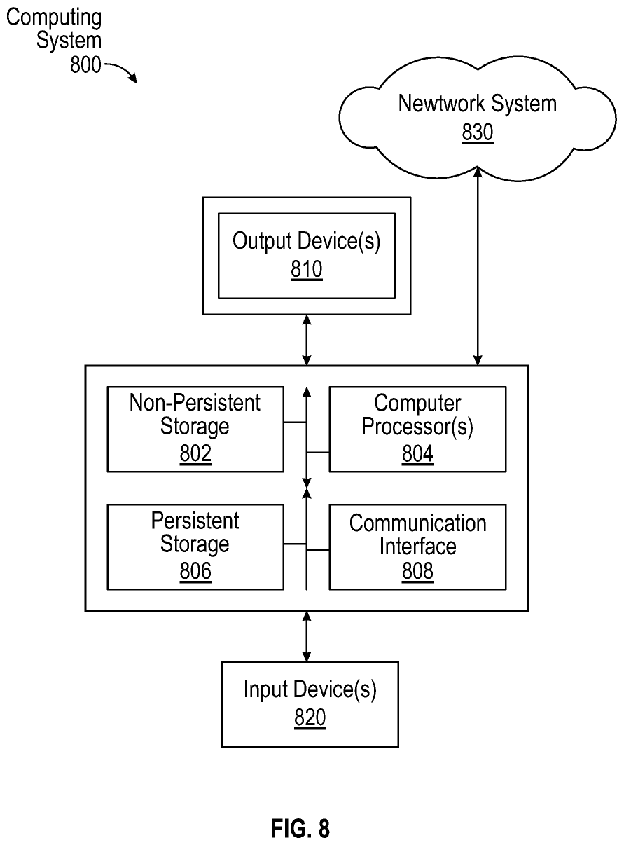

Turning to FIG. 2, FIG. 2 shows an overall workflow in accordance with one or more embodiments. Specifically, FIG. 2 describes a general workflow for constructing a coarse low-fidelity model to obtain updated priors, constructing a fine low-fidelity model, utilizing Bayesian optimization to obtain posteriors, and determining accuracy and physical consistency of a high-fidelity reservoir simulation model. One or more steps in FIG. 2 may be performed by one or more components as described in FIG. 1. For example, the history matching manager (100) may be executed on any suitable computing device, such as computer system shown in FIG. 8, to perform one or more steps in FIG. 2. While various steps in FIG. 2 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

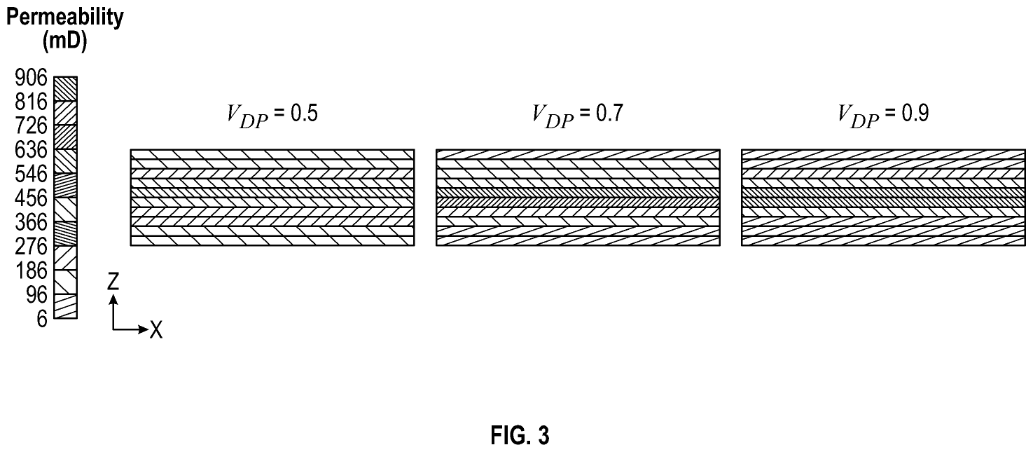

In Step 201, a reservoir simulation model of interest for history matching is selected. For example, the selected reservoir simulation model may refer to the high-fidelity reservoir model (150) as illustrate in FIG. 1. In some embodiments, the high-fidelity reservoir model may be 2D cross section of a studied reservoir simulation model. FIG. 3 shows a plurality of 2D cross sections of a studied reservoir simulation model. Specifically, FIG. 3 represents a variation in vertical permeability with an increasing permeability from left to the right.

In Step 202, mathematical models relevant to the reservoir simulation model of interest is identified. For example, the selected reservoir simulation model may identify as a mathematical model representing water injection into an oil reservoir at a constant temperature, including only one water injector and one oil producer. The identified mathematical model is referred as water injection model below for illustration purposes. However, examples of the mathematical models identified in Step 202 is not limited to the above example, and may comprise, for example, 3D gas injection into an oil reservoir.

Step 202 is necessary to understand the physics of the problem and to ensure consistency of the high-fidelity reservoir model. Specifically, the physics of the problem refers to governing equations that describe physics of the high-fidelity reservoir model. Consistency of the high-fidelity reservoir model refers to whether predicted posteriors would capture the physics of the model. Taking the water injection model as example, fluid flow properties can be predicted by solving the mass conservation and momentum equation in 2D, which are as equations (2)-(6):

$$\frac{\partial }{\partial t} ( {ϕρ}_{η} {S}_{η} ) + ∇ \cdot ( {ρ}_{η} {u}_{η} ) = {Q}_{η} η = \{ o , w \} \qquad ( 2 )$$

$${u}_{η} = - \frac{k {k}_{r η}}{{ζ}_{η}} ∇ {Φ}_{η} \qquad ( 3 )$$

$${Φ}_{η} = {P}_{η} - {ρ}_{η} ζ z \qquad ( 4 )$$

$$RF ( t ) = \frac{{{\int }_{0}}^{t} {Q}_{po} dt}{ϕ \cdot RV \cdot {B}_{o}} \qquad ( 5 )$$

$${t}_{D} = \frac{{Q}_{iw} t}{ϕ \cdot RV} \qquad ( 6 )$$

where t is time, ϕ is the porosity of a reservoir, ρ is the phase density, S is the fluid phase saturation in the reservoir, u is the phase superficial velocity, and Q is the phase sink/source term. k is the absolute permeability of the reservoir, kᵣ is the phase relative permeability, ζ is the phase dynamic viscosity, and Φ is the phase potential. P is the phase pressure, ζ is the gravitational acceleration, and z is the phase hydrostatic height. Qₚ is production rate, RV is reservoir bulk volume, and B is formation volume factor. t_{D} is dimensionless time and Qᵢ is injection rate. The subscription η denotes the phase where o is oil and w is water.

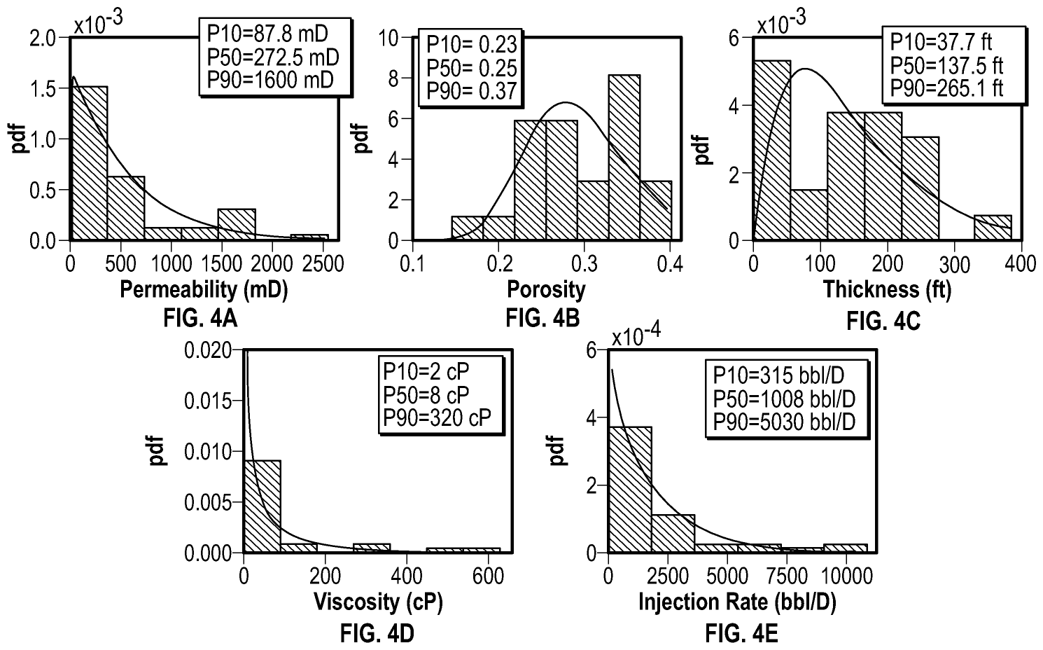

In Step 203, a set of history matching parameters with associated uncertainty are obtained to identify initial priors. Specifically, the history matching parameters are the uncertain parameters that control variance and precision of the reservoir simulation model's prediction. Each history matching parameter is described with a distribution and variability (upper and lower bounds). Such distributions are taken as the initial priors. Take the water injection model as example, identified history matching parameters comprise permeability, porosity, thickness, oil viscosity, and water injection rate. FIG. 4 shows distributions of these five identified parameters, which are taken as initial priors to further perform history matching for the selected reservoir simulation model of interest from Step 201. For example, the history matching parameters may refer to the history matching parameters (155), and the initial priors may refer to the initial priors (156) described in FIG. 1.

In Step 204, a coarse low-fidelity model is constructed to obtain updated priors. Specifically, the coarse low-fidelity model is constructed using space-filling DoE, and the space-filling DoE uses LHS as statistical sampling. Space-filling DoE provides uniform filling of a design space for a special number of samples or generates sequences reasonably uniformly distributed when terminated at any point. Space-filling DoE supports the generation of Latin Hypercubes. LHS is a statistical method for generating a near-random sample of parameters from a multidimensional distribution and is often used to construct experiment for MCMC algorithms. For example, the constructed coarse low-fidelity model may refer to the coarse low-fidelity PCE model (130) utilizing coarse (less datasets) LHS (135) described in FIG. 1. The update priors may refer to the updated priors (170) in FIG. 1.

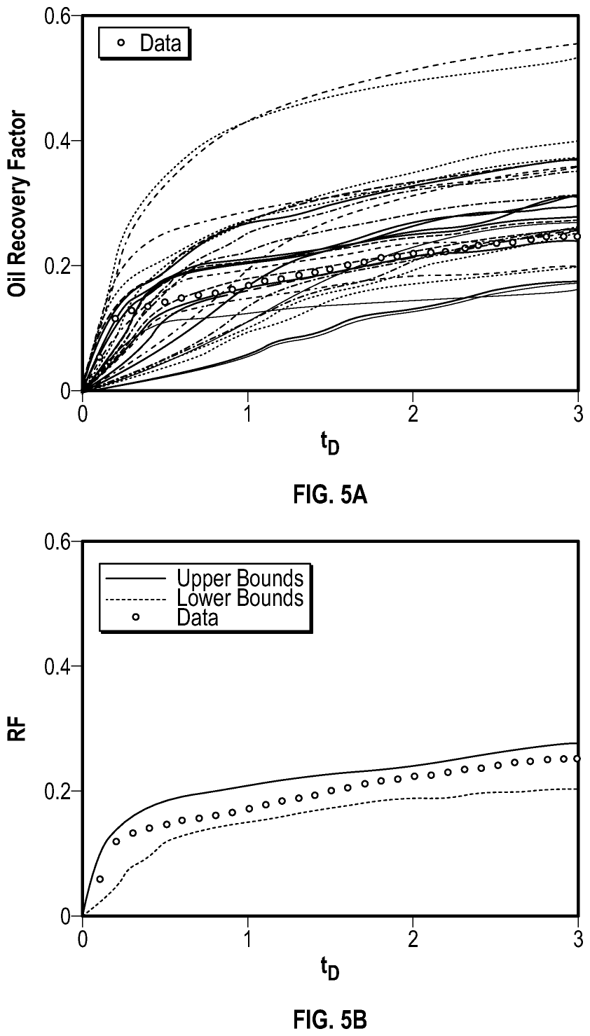

For example, FIG. 5 reflects the initial priors and the updated priors for history matching the water injection model. In FIG. 5, section (a) shows randomly picked bounding lines from 25 realizations of a coarse PCE model. The exact ranges of the optimum bound lines were: V_{DP}=0.63-0.89, ζₒ=110.12-199.16 cP, kᵣₒ=0.64-0.77, and Q_{iw}=362.15-2,272 bbl/D, which are Dykstra-Parson coefficient (for measuring vertical heterogeneity), oil viscosity, relative permeability and water injection rate, respectively. In FIG. 5, section (b) shows updated bounding lines of the 25 realizations from section (a). In particular, the updated bounding lines are assigned based on response's space exploration through the coarse low-fidelity model. More details of obtaining updated priors utilizing the coarse low-fidelity model are explained below in FIG. 7B and the accompanying description.

In Step 205, a fine low-fidelity model is constructed to obtain posteriors. Similar to constructing the coarse low-fidelity model, the fine low-fidelity model is constructed using space-filling DoE, which further uses LHS as statistical sampling, but with a larger training set. The updated priors obtained from Step 204 are used as initial inputs to develop the posteriors using Bayesian-optimized Adaptive MCMC workflow. Particularly, resolution of a low-fidelity model is proportional to the size of a training set that is used to train the low-fidelity model. As such, the coarse low-fidelity PCE model may use a smaller training set compared to the fine low-fidelity PCE model. For example, the fine low-fidelity model may refer to the fine low-fidelity PCE model (140) utilizing fine (more datasets) LHS (145) described in FIG. 1. The posteriors may refer to the posteriors (190) in FIG. 1. More details of the Bayesian-optimized Adaptive MCMC workflow are explained below in FIG. 7A and the accompanying description.

In Step 206, the posteriors obtained from Step 205 are imported in the reservoir simulation model of interest selected in Step 201 to check accuracy and physical consistency of the reservoir simulation model.

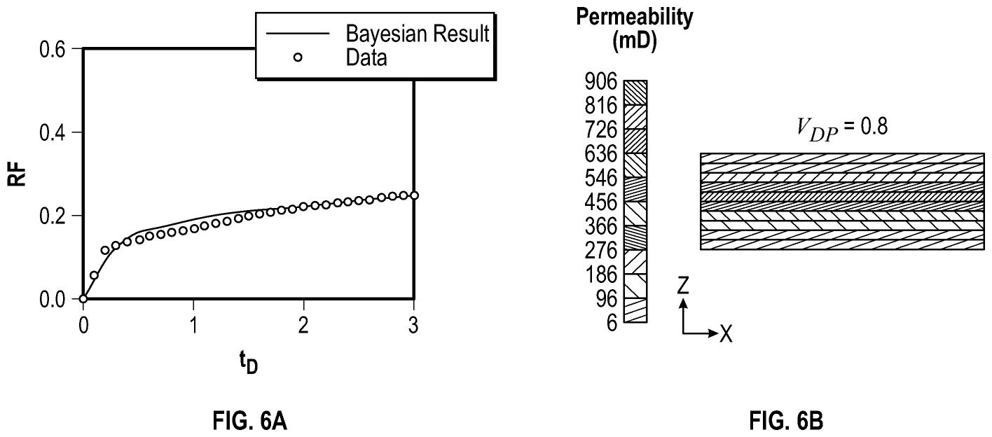

In Step 207, determine if P₅₀ prediction matches measured data. Specifically, P₅₀ prediction is the 50th percentile (median) in a probability distribution of an uncertain parameter. In some embodiments, P₅₀ of the posteriors is fed back to the selected reservoir simulation model to compare with the measured data. The measured data refer to data the high-fidelity model wants to match. In some embodiments, the measured data may come from actual field measurements, such as pressures, oil recovery, gas oil ratio, etc. If the determination result is yes, the history matching produces accurate and physically consistent results. Then, the flowchart goes to Step 208 and outputs the corresponding posteriors as final posteriors. With that, the process ends. If the determination is no, the flowchart goes to Step 209. FIG. 6 shows an example of comparing the P₅₀ prediction and measured data in the water rejection model, wherein section (a) shows a comparison between data and high-fidelity prediction using Bayesian's posteriors, and section (b) shows permeability realization from P₅₀ posterior.

In Step 209, a determination of the quality of the fine low-fidelity model is made. If the quality is good, the procedure goes back to Step 203 to inspect the history matching parameters in terms of initial prior ranges and distributions. If the quality is poor, the procedure goes back to Step 205 to retrain the fine low-fidelity model with a larger training set.

In Step 210, upon determining that the P₅₀ prediction matches the measured data, the selected reservoir simulation model is determined as being matched and accurate. This matched reservoir simulation model is further utilized to make production predictions of the reservoir, for example, to predict oil and gas productions in the reservoir. In some embodiments, the matched reservoir simulation model may be used in determining recovery schemes for the reservoir.

Those skilled in the art will appreciate that the process of FIG. 2 may be repeated for history matching any reservoir simulation models of interest.

Turning to FIG. 7A, FIG. 7A provides an example of a Bayesian MCMC workflow that is adopted in some embodiments of the disclosure. The following example is for explanatory purposes only and not intended to limit the scope of the disclosed technology.

As shown in FIG. 7A, history matching parameters (701) are identified from a high-fidelity reservoir model (700), the latter of which is a selected reservoir simulation model of interest. The identified history matching parameters (701) are set as initial priors (702) in the Bayesian MCMC workflow.

As convergence and precision Bayesian MCMC workflow highly depend on prior selection, the initial priors (702) are updated through a coarse low-fidelity PCE model (710) to obtain updated priors (703). For example, coarse low-fidelity PCE model (710) may refer to the coarse low-fidelity PCE model (130) in FIG. 1 and may be constructed as described in Step 204 in FIG. 2 by using LHS. In particular, the coarse low-fidelity model mainly focus on non-informative priors, such as uniform distributions.

FIG. 7B shows a detailed workflow for updating the priors, wherein m is a sample from the initial priors that was selected by LHS. d is a bounding line from a realization of the coarse low-fidelity model. dᵤₚₚₑᵣ and d_{lower} are the picked bounding lines, associated with mᵤₚₚₑᵣ and m_{lower}. Particularly, m is an vector including all matching parameters as input. This input is fed into the coarse low-fidelity model to generate corresponding output represented by d. R represents real numbers. m is generated from Latin Hypercube using either 20, 25, or 30 samples. d is obtained from regression.

The workflow in FIG. 7B starts by taking a plurality of samplers using Latin Hypercube. In particular, 20-30 samplers (Nₛₐₘₚₗₑₛ) may be taken. Realizations from the coarse low-fidelity model should bound the measured data. Specifically, the new bounding lines should satisfy the following requirements: (1) cover at least 5-10% distance from the data; (2) not being too wide; and (3) data are roughly put in the center of the new bounds. Particularly, the bounding lines may not be unique. All bounding lines that follow the previous suggestions should be picked. As the number of samples increases, the number of bounding lines to be considered also increases. However, there are not any overlapping bounds by increasing the number of samples. The overall process to decide the optimum bounding lines is iterative. The optimum bounding lines are determined after the Bayesian MCMC run.

Keeping with FIG. 7A, the updated priors (703) are used as the initial inputs for Bayesian MCMC workflow to generate posteriors (704). Further, to reduce the computational cost, a fine low-fidelity PCE model (720) is constructed for likelihood calculation. Specifically, sensitivity analysis on the number of training data generated through Latin Hypercube (725) is performed to construct the fine low-fidelity PCE model (720). Furthermore, hyperparameters in the MCMC are tuned (706) using Bayesian optimization (750). Hyperparameters are parameters that are used to control evolution of posteriors' covariance and chain's properties in MCMC. The Bayesian optimization (750) optimizes discrepancy between P₅₀ prediction and measured data (705). Posteriors (704) are obtained by solving Bayesian MCMC. In some embodiments, Bayesian MCMC may be solved by utilizing UQLab software using Adaptive Metropolis algorithm (730). In some embodiments, the Adaptive Metropolis algorithm (730) used in Bayesian MCMC is described in Table 1.

Further, the posteriors (704) obtained from the MCMC is fed into the high-fidelity model (700) to ensure accuracy and physical consistency. Specifically, upon determining that the posteriors (704) match the measured data, the history matching produces accurate and physically consistent results. In some embodiments, upon determining that discrepancy between the posteriors and the measured data (707) is good, the corresponding posteriors are determined as final posteriors (708).

Upon determining that the posteriors (704) do not match the measured data, in some embodiments, the following two inspections may be performed in order to improve the history matching results. The first inspection (740) is to check quality of the fine low-fidelity PCE model (720). Accuracy of fine low-fidelity PCE model (720) determines convergence and reliability of the Bayesian MCMC results. The fine-low fidelity PCE model (720) may be revised by increasing number of training samples. The second inspection (760) is to revise the matching parameters (701) and check physics of the high-fidelity reservoir model (700). Particularly, checking physics is to better understand recovery mechanisms in the reservoir and to look for any neglected uncertainty parameters. In addition to the above inspections, other possible that could lead to poor history matching results between the predicted and measured data should also be considered. As such, additional inspections on or adjustment to the other components in the Bayesian MCMC workflow may also be performed.

TABLE 1
Multi-Chain Adaptive Metropolis algorithm

```
Input: prior distribution of m , number of iterations Nᵢₜₑᵣ , number of chains N_{chains}
parfor w = 1, . . . , N_{chains} do
  Initialize m^{(0,w)}
  for k = l, . . . , Nᵢₜₑᵣ do
    Calculate s_{d} · Σ(k)
    Propose m^{(*)} ~ p(m^{(*,w)} | m^{(0,w)}, . . . , m^{(k-1,w)})
    $Compute {α}^{( k )} = min \{ 1 , \frac{p ( {m}^{\text{(*} , w )} \vert d , G ) p ( {m}^{( 0 , w )} , … , {m}^{( k - 1 , w )} \vert {m}^{\text{(*} , w )} )}{p ( {m}^{( k - 1 , w )} \vert d , G ) p ( {m}^{\text{(*} , w )} \vert {m}^{( 0 , w )} , … , {m}^{( k - 1 , w )} )} \}$
    Generate u ~ U(0,1)
    If u ≤ α^{(k)} then m^{(k,w)} ← m^{(*,w)} else m^{(k,w)} ← m^{(k-1,w)}
  end
end
```

While FIG. 7A shows various components, other components may be used without departing from the scope of the disclosure. For example, various components in FIG. 7A may be combined to create a single component. As another example, the functionality performed by a single component may be performed by two or more components.

Turning to FIG. 8, FIG. 8 shows a computing system in accordance with one or more embodiments. As shown in FIG. 8, the computing system 800 may include one or more computer processor(s) 804, non-persistent storage 802 (e.g., random access memory (RAM), cache memory, or flash memory), one or more persistent storage 806 (e.g., a hard disk), a communication interface 808 (transmitters and/or receivers) and numerous other elements and functionalities. The computer processor(s) 804 may be an integrated circuit for processing instructions. The computing system 600 may also include one or more input device(s) 820, such as a touchscreen, keyboard, mouse, microphone, touchpad, electronic pen, or any other type of input device. In some embodiments, the one or more input device(s) 820 may be the GUI (110) described in FIG. 1 and the accompanying description. Further, the computing system 800 may include one or more output device(s) 810, such as a screen (e.g., a liquid crystal display (LCD), a plasma display, or touchscreen), a printer, external storage, or any other output device. One or more of the output device(s) may be the same or different from the input device(s). The computing system 800 may be connected to a network system 830 (e.g., a local area network (LAN), a wide area network (WAN) such as the Internet, mobile network, or any other type of network) via a network interface connection (not shown).

In one or more embodiments, for example, the input device 820 may be coupled to a receiver and a transmitter used for exchanging communication with one or more peripherals connected to the network system 830. The receiver may receive information relating to the history matching of the reservoir simulation model as described in FIGS. 1-7. The transmitter may relay information received by the receiver to other elements in the computing system 800. Further, the computer processor(s) 804 may be configured for performing or aiding in implementing the processes described in reference to FIGS. 2-7.

Further, one or more elements of the computing system 800 may be located at a remote location and be connected to the other elements over the network system 830. The network system 830 may be a cloud-based interface performing processing at a remote location from the well site and connected to the other elements over a network. In this case, the computing system 800 may be connected through a remote connection established using a 5G connection, such as protocols established in Release 15 and subsequent releases of the 3GPP/New Radio (NR) standards.

The computing system in FIG. 8 may implement and/or be connected to a data repository. For example, one type of data repository is a database (i.e., like databases). A database is a collection of information configured for ease of data retrieval, modification, re-organization, and deletion. In some embodiments, the databases include published/measured data relating to the method, the systems, and the devices as described in reference to FIGS. 2-7.

While FIGS. 1-8 show various configurations of components, other configurations may be used without departing from the scope of the disclosure. For example, various components in FIGS. 1 and 7 may be combined to create a single component. As another example, the functionality performed by a single component may be performed by two or more components.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. A method for history matching utilizing Bayesian Markov Chain Monte Carlo (MCMC) workflow, comprising:
selecting, by a computer processor, a reservoir simulation model of interest;
identifying, by the computer processor, a mathematical model relevant to the reservoir simulation model;
identifying, by the computer processor, a plurality of history matching parameters relevant to the reservoir simulation model as initial priors;
constructing, by the computer processor utilizing the initial priors, a first model;
obtaining, by the computer processor and utilizing the first model, updated priors;
constructing, by the computer processor and utilizing the updated priors, a second model;
obtaining, by the computer processor and utilizing the second model, posteriors;
determining, by the computer processor, history matching accuracy of the reservoir simulation model by comparing medians of the posteriors and a plurality of measured data, and
upon determining that the reservoir simulation model is accurate, performing, by the computer processor utilizing the reservoir simulation model, a plurality of predictions associated with a reservoir,
wherein the second model represents the reservoir simulation model;
wherein the Bayesian MCMC workflow automatically tunes hyperparameters; and
wherein the plurality of predictions comprise predictions of oil and gas production from the reservoir.

2. The method of claim 1,
wherein the first model is a coarse low-fidelity Polynomial Chaos Expansion (PCE) model; and
wherein the second model is a fine low-fidelity PCE model,

3. The method of claim 2,
wherein the first model is trained by a first training set, and the second model is trained by a second training set; and
wherein, the first training set has a smaller size than the second training set.

4. The method of claim 3, wherein the first and second models are constructed utilizing Latin Hypercube Sampler (LHS).

5. The method of claim 1, further comprising:
determining, by the computer processor, if the medians of the posteriors matches the plurality of measured data,
upon determining that the medians of the posteriors matches the plurality of measured data, identifying, by the computer processor, the medians of the posteriors as final posteriors; and
upon determining that the medians of the posteriors does not match the plurality of measured data, performing, by the computer processor, a plurality of inspections.

6. The method of claim 5, wherein the plurality of inspections comprise determining quality of the second model and revising the history matching parameters.

7. The method of claim 6, wherein upon determining that the quality of the second model is poor, constructing, by the processor, an updated second model with a new training set.

8. The method of claim 6, wherein upon determining that the quality of the second model is good, constructing, by the computer processor, an updated first model with updated history matching parameters.

9. A system for performing history matching utilizing Bayesian Markov Chain Monte Carlo (MCMC) workflow, comprising:
a computing device with a computer processor, the computing device executing a history matching manager configured to:
select a reservoir simulation model of interest;
identify a mathematical model relevant to the reservoir simulation model;
identify a plurality of history matching parameters relevant to the reservoir simulation model as initial priors;
construct, utilizing the initial priors, a first model;
obtain, utilizing the first model, updated priors;
construct, utilizing the updated priors, a second model;
obtain, utilizing the second model, posteriors;
determine history matching accuracy of the reservoir simulation model by comparing medians of the posteriors and a plurality of measured data, and
upon determining that the reservoir simulation model is accurate, perform, utilizing the reservoir simulation model, a plurality of predictions of a reservoir,
wherein the second model represents the reservoir simulation model;
wherein the Bayesian MCMC workflow automatically tunes hyperparameters; and
wherein the plurality of predictions comprise predictions of oil and gas production from the reservoir.

10. The system of claim 9,
wherein the first model is a coarse low-fidelity Polynomial Chaos Expansion (PCE) model; and
wherein the second model is a fine low-fidelity PCE model,

11. The system of claim 10,
wherein the first model is trained by a first training set, and the second model is trained by a second training set; and
wherein, the first training set has a smaller size than the second training set.

12. The system of claim 11, wherein the first and second models are constructed utilizing Latin Hypercube Sampler (LHS).

13. The system of claim 9, the history matching manager is further configured to:
determine if the medians of the posteriors matches the plurality of measured data,
upon determining that the medians of the posteriors matches the plurality of measured data, identify the medians of the posteriors as final posteriors; and
upon determining that the medians of the posteriors does not match the plurality of measured data, perform a plurality of inspections.

14. The method of claim 13, wherein the plurality of inspections comprise determining quality of the second model and revising the history matching parameters.

15. The method of claim 14, wherein upon determining that the quality of the second model is poor, construct an updated second model with a new training set.

16. The method of claim 14, wherein upon determining that the quality of the second model is good, construct an updated first model with updated history matching parameters.

17. A non-transitory computer readable medium storing instructions executable by a computer processor, the instructions comprising functionality for:
selecting a reservoir simulation model of interest;
identifying a mathematical model relevant to the reservoir simulation model;
identifying a plurality of history matching parameters relevant to the reservoir simulation model as initial priors;
constructing, utilizing the initial priors, a first model;
obtaining, utilizing the first model, updated priors;
constructing, utilizing the updated priors, a second model;
obtaining, utilizing the second model, posteriors;
determining history matching accuracy of the reservoir simulation model by comparing medians of the posteriors and a plurality of measured data, and
upon determining that the reservoir simulation model is accurate, performing, utilizing the reservoir simulation model, a plurality of predictions of a reservoir,
wherein the second model represents the reservoir simulation model;
wherein the Bayesian MCMC workflow automatically tunes hyperparameters; and
wherein the plurality of predictions comprise predictions of oil and gas production from the reservoir.

18. The non-transitory computer readable medium of claim 17,
wherein the first model is a coarse low-fidelity Polynomial Chaos Expansion (PCE) model; and
wherein the second model is a fine low-fidelity PCE model,

19. The non-transitory computer readable medium of claim 18,
wherein the first model is trained by a first training set, and the second model is trained by a second training set; and
wherein, the first training set has a smaller size than the second training set.

20. The non-transitory computer readable medium of claim 19, wherein the first and second models are constructed utilizing Latin Hypercube Sampler (LHS).
